(19) United States
(12) Patent Application Publication
(10) Pub. No.: US 2012/0144654 A1
(43) Pub. Date: Jun. 14, 2012

(54) YARD ARM

(76) Inventors: RANDY CHRISTIAN, Lubbock, TX (US); STAN ROBERTSON, Lubbock, TX (US)

(21) Appl. No.: 13/314,578

(22) Filed: Dec. 8, 2011

Related U.S. Application Data
(60) Provisional application No. 61/420,867, filed on Dec. 8, 2010.

(51) Int. Cl. F21V 21/00; A47G 7/02; B23P 11/00; F16M 13/02

(52) U.S. Cl. 29/525.08; 248/219.2; 248/27.8

(57) ABSTRACT

A fence pole mounted device for hanging one or more items.

### CROSS REFERENCE TO RELATED APPLICATIONS

This application claims the benefit of provisional application 61/420,867 filed Dec. 8, 2010 by the present inventors and the same is incorporated hereto in its entirety.

### STATEMENT REGARDING FEDERALLY SPONSORED RESEARCH OR DEVELOPMENT

Not Applicable

### NAMES OF PARTIES TO JOINT RESEARCH AGREEMENT

Not Applicable

### REFERENCE TO SEQUENCE LISTING

Not Applicable

### DESCRIPTION OF ATTACHED APPENDIX

Not Applicable

### BACKGROUND OF THE INVENTION

1. Field of the Invention

The disclosed relates generally to a novel method and device for aesthetically and effectively supporting one or more plants or other items on a fence and more specifically to a multi-purpose fence pole mounted hanging device.

2. Description of Related Art

A variety of plant hangers and decorative hangers are known in the prior art which are somewhat useful for hanging items from a fence. For example, U.S. Pat. No. 6,003,824 describes a method of hanging a clay flowerpot, the hanger being specifically designed for latching onto a fence and providing a support from which a flowerpot can be hung. The hanger is essentially hidden from view behind the flowerpot, and serves the singular purpose of supporting the pot. Because of its very specific design, it can only be used with a clay flowerpot and saucer.

U.S. Pat. No. 7,024,816 describes a plant container hanger that can be suspended from a support rail such as a chain link fence. This hanger is very specifically designed to hang over only a chain link fence and provides a circular support to encircle a plant container and a support arm beneath the circular support, on which the plant container can rest.

U.S. Pat. No. 5,457,911 describes a Fence Mounted Hanger for suspending potted plants or ornamentation from chain-link, lattice or similar fencing but it does not appear to be suitable for use with the far more popular wooden privacy fences.

U.S. Pat. No. 4,666,115 is a plant hanger that is geared more toward use with privacy fences however it is a utilitarian looking V shaped support member that has to incorporate various support and strengthening members in order to hold the weight of a plant, as the hanger mounts on the actual pickets of the wood fence.

There is a need for a fence mounted hanger that can be used on a variety of types of fences, that can support enough weight to accommodate a heavy flower pot, that adds an aesthetic element to its environment, even when no items are being hung on it, and that is versatile enough in its design that it can be used for purposes other than just hanging flowerpots. The hanger needs to be easily installable and removable. The previously described patents lack the above described features.

### SUMMARY OF THE INVENTION

In accordance with the present invention, a method and device is disclosed for a novel fence pole mounted hanging device that serves both an aesthetic and versatile purpose.

An objective of the disclosure is a hanging device that can be used on cyclone, chain link, privacy wood and fences made from other materials.

An objective of the disclosure is a hanging device that can be mounted in or on a fence pole.

An objective of the disclosure is a fence mounted hanging device from which can be hung plant containers.

An objective of the disclosure is a fence mounted hanging device from which can be hung security or decorative lighting.

An objective of the disclosure is a fence mounted hanging device from which can be hung security wire.

An objective of the disclosure is a fence pole mounted hanging device which is easily installable and may be removable if desired or may be secured permanently.

An objective of the disclosure is a fence mounted hanging device that will support more than one plant container or object at a time.

An objective of the disclosure is a fence mounted hanging device that can support objects at a higher or more appropriate elevation than the hangers currently disclosed in the prior art.

An objective of the disclosure is a fence mounted hanging device that has a fixedly mounted sleeve into which interchangeable support arms can be placed for a variety of purposes.

Other objects and advantages of the present invention will become apparent from the following descriptions, taken in connection with the accompanying figures, wherein, by way of illustration and example, an embodiment of the present invention is disclosed.

### BRIEF DESCRIPTION OF THE DRAWINGS

The figures constitute a part of this specification and include exemplary embodiments to the invention, which may be embodied in various forms. It is to be understood that in some instances various aspects of the invention may be shown exaggerated or enlarged to facilitate an understanding of the invention. To enable more thorough understanding of the features and advantages of the present invention, reference is now made to the detailed description of the invention along with the accompanying figures in which:

FIG. 1 is a side view of a preferred embodiment of the disclosed.

FIG. 2a is a perspective view of a preferred embodiment of the disclosed.

FIG. 2b is a close up side view of a preferred embodiment of the disclosed.

FIG. 2c is a close up perspective view of a preferred embodiment of the disclosed.

FIG. 3 is a side view of an embodiment of the disclosed support arm.

FIG. 4a is a side view of an embodiment of the disclosed support arm.

FIG. 4b is a side view of an embodiment of the disclosed support arm.

FIG. 4c is a rear view of an embodiment of the disclosed support arm.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The disclosed invention is a novel fence pole mounted hanging device having versatility and aesthetic features. When used as a hanger for a plant container, the disclosed device uniquely allows for more than one plant container to be supported at once, while offering more sturdy and substantial support for even heavy plant containers. It can hold objects at a greater height than the known fence hangers, which is both more aesthetic to the eye and more useful. The device offers a versatile commercial application in that it can be used on various types of fences, such as cyclone and other fences, to aesthetically and effectively support security wire or lighting. It can be used to support decorative or security lighting for residential purposes. A fence mounted plant hanging device capable of holding both one or more plant containers plus security wire or lighting is believed to be unknown in the prior art.

The disclosed fence pole mounted hanging device is mounted on the fence pole, rather than just a section of the fence, which, in addition to its novel design, enables it to provide extremely strong support. This is also useful in that fence poles are placed consecutively, at equi-distance apart, allowing for aesthetic and constructive placement of the fence mounted hangers. The majority of cyclone, chain link, and wood privacy fences are supported by means of galvanized metal poles placed several feet apart. The metal poles are typically placed in deep holes having poured concrete. Once the concrete sets, the pole is rigid and thus can support the fence panels, as well as provide superior support for the disclosed device.

Of all the patents and published applications reviewed, none offer the advantages described herein and none utilize the fence pole, rather than the fence panel or section, as the structure to support the fence mounted hanging device.

The disclosed fence pole mounted hanging device is specially designed so that it is easy to install and remove, if desired, yet is extremely strong and stable. It may be permanently mounted if desired. Because it is mounted to the fence pole, rather than the fence itself, it is capable of holding objects of greater weight at a higher elevation. This and the other novel features of the disclosed hanger result in a substantial advantage in versatility and utility, enabling the support of not only plant containers, but also security wire, lighting, decorations and other items. The multiple components of the disclosed enables interchangeability and customization of features, creating a true “yard arm” to enhance one's outdoor area.

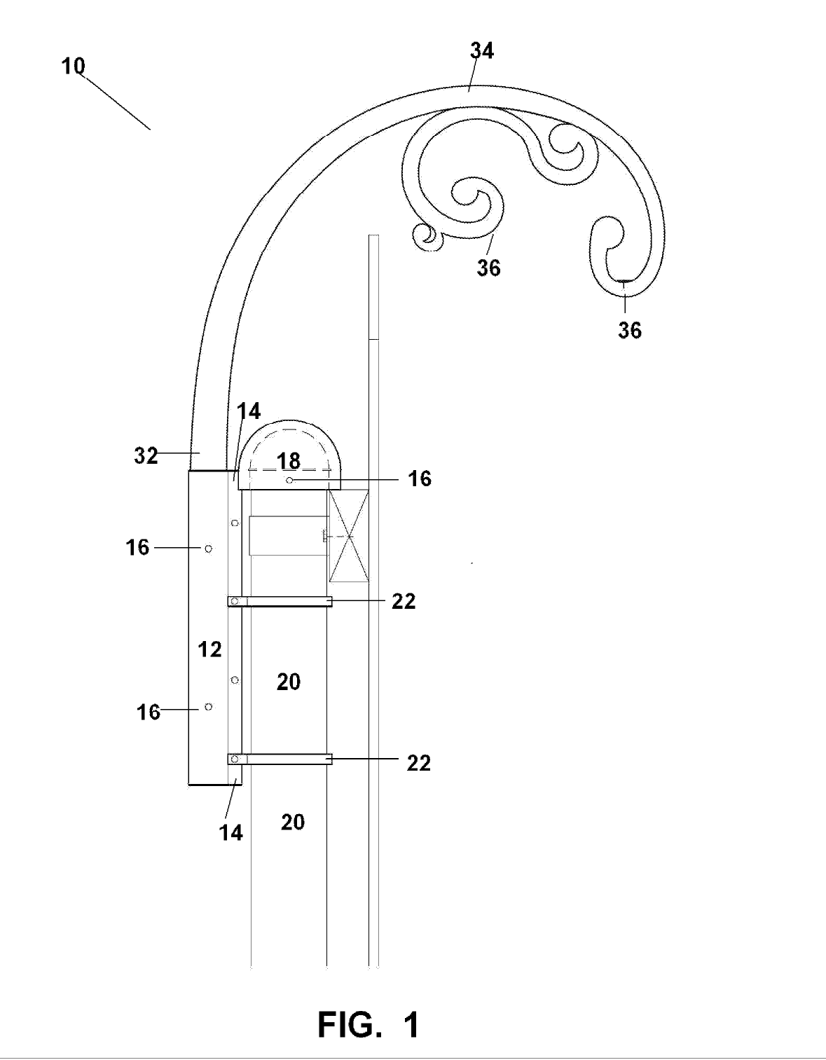

Turning to FIG. 1, in a preferred embodiment, the disclosed fence pole mounted hanging device comprises essentially a hollow sleeve, a metal pole cap, metal support straps and one or more interchangeable curved arms having one or more decorative hooks from which objects can be hung. The hanger is mounted to an existing fence pole which in the prototype example was galvanized metal, although other types of fence poles may be used. Fence poles are typically cylindrical or square.

In the preferred embodiment, the hollow sleeve and cap are a one piece component that is mounted to the pole by support straps, screws and nuts. The chosen interchangeable support arm slides into the sleeve and can be secured in place by screws and nuts or other fastener combinations. Various support arms can be used with the same fixedly mounted sleeve, enabling a variety of uses. As an example, a user may wish to employ one type of decorative arm in the summertime to hold plants. In the winter the user may wish to remove the support arm and replace it with a different arm, one having certain hooks or a look more specific for holding lighting or holiday decorations. The different types of arms that may be inserted into the sleeve are infinite, enabling a variety of residential and commercial uses for the fence mounted hanger. Curved support arms are preferred for support and aesthetic reasons although other shapes may be contemplated.

In FIG. 1 the hanging device 10 is illustrated having a hollow sleeve 12 with a flat edge 14 protruding from one side of the hollow sleeve 12, on which edge 14 are evenly spaced apart holes 16 for securing the sleeve against the fence pole. At the top end of the hollow sleeve, from the flat edge 14 extends out perpendicularly a dome shaped cap 18 of a size and shape for fitting over an existing fence pole 20. At the bottom edge of the cap 18 may be one or more holes 16 for securing the cap 18 to the top of the fence pole 20, using a screw or other similar fastening means.

The hollow sleeve 12 extends downward parallel against the fence pole and may be mounted against the pole 20 using circular metal straps 22 having holes 16 whereby the straps 22 can encircle the pole 20 and fasten to the flat edge 14 of the sleeve 12, holding the sleeve 12 all the way down to its bottom end securely to the pole 20. Depending on the type of fastener used the device may be removable secured to the pole. Because the cap 18 fits over the top of the fence pole 20, the sleeve 12 is held even more securely against the fence pole 20, providing leverage and strength for holding a heavy item. Protruding from the hollow sleeve is pictured a support arm 30 having one or more hooks 36 from which to hang one or more objects, such as a potted plant, security wiring, lighting or other desired items.

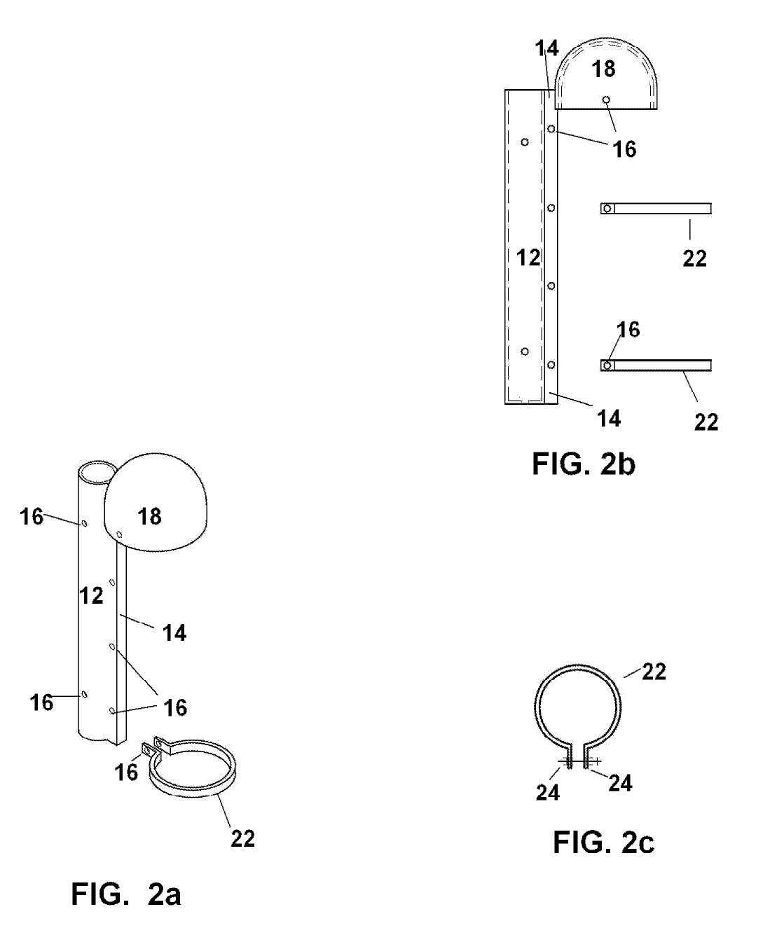

FIG. 2a reveals a perspective view of the one piece sleeve 12 showing the flat edge 14 and cap 18. Also pictured is the support strap 22. In FIG. 2b is a close up side view of the FIG. 2 sleeve 12 having the flat edge 14 and the cap 18. Also pictured are the holes 16 for fastening.

FIG. 2c is a close-up perspective view of the support strap 22, further illustrating that the strap, which may be constructed of iron, steel, metal, plastic or other reasonable strong and durable outdoor material, is circular and has a first and second end, each end culminating in a rigid perpendicular flange 24, the two flanges 24 parallel to and adjacent to each other and each flange having a hole 16 for fastening. In practice, the support strap 22 encircles the pole 20 and the two flanges 24 are situated on either side of the flat edge 14 of the sleeve 12. Both flange 24 holes 16 are lined up with the corresponding hole 16 on the sleeve 12 so that a screw can thread through all three holes and be fastened securely thereto with a nut or similar fastening means.

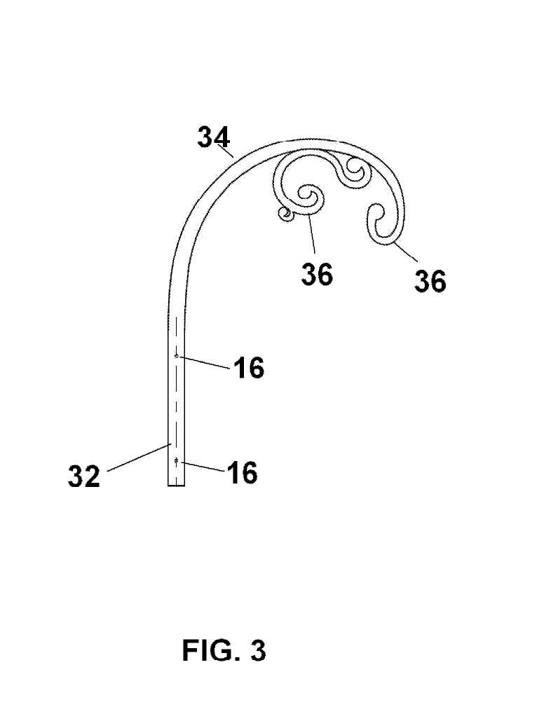

In FIG. 3 is illustrated the preferred embodiment of the support arm 30, which, in the preferred embodiment is curved as pictured. The arm as pictured is comprised of a rigid vertical base piece 32 progressing into a curved support piece 34. The base piece 32 of the arm 30 is of a corresponding size and shape that it can slide easily into the hollow sleeve 12. Once inserted the base piece 32 is securely fastened to the sleeve 12 by means of screws threaded through the fastening holes 16 or other means of fastening that achieve the herein disclosed objectives of easy and secure installation and support. The curved support piece 34 may have a decorative and aesthetic design to it, if desired, as shown in FIG. 3. On the curved support piece are one or more hooks 36 on which can be hung plant containers, security wire, lighting, or decorative accessories. Various modifications of arms may be manufactured that are interchangeable with the fixedly mounted sleeve, such that a user can, once they have mounted the sleeve, remove and interchange various arms having a multitude of designs or uses. For example, perhaps a right angle arm may be desired rather than the curved support arm for certain uses, such as for the security wire or lighting.

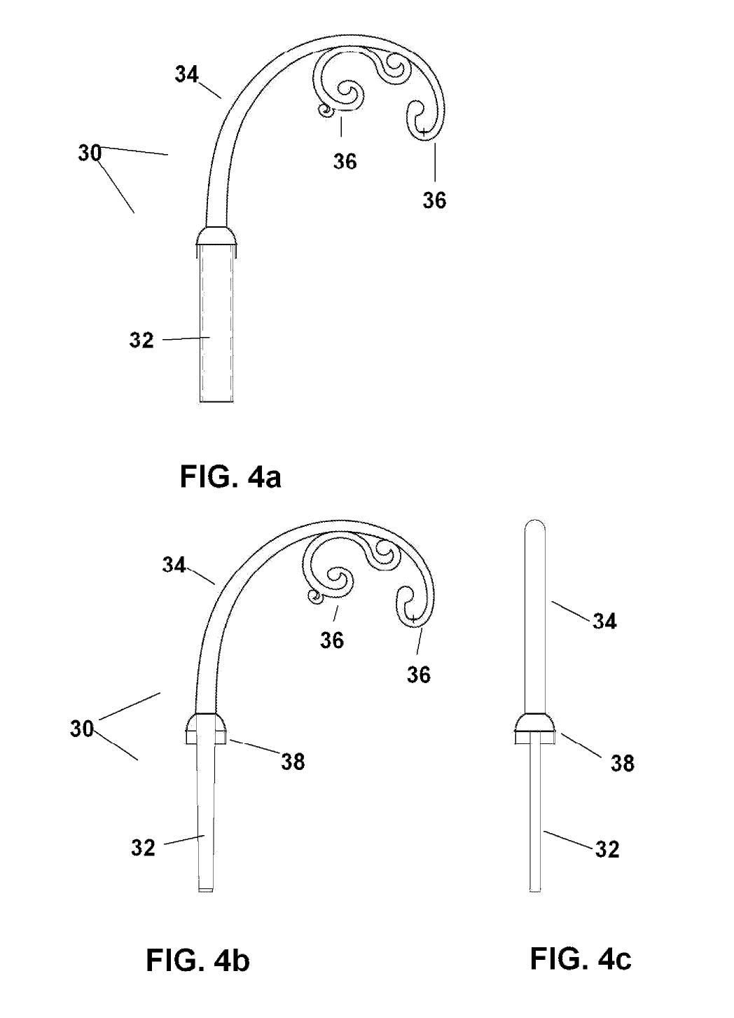

FIG. 4a illustrates a side view of the curved arm 30 in more detail. Revealed more closely are the rigid vertical base piece 32 and the curved support piece 34. The decorative component to the curved support piece 34 is readily ascertainable as well as the hooks 36 from which the objects are hung. The hooks may be of various shapes, styles and locations on the support piece 34. In FIGS. 4b and 4c are pictured alternative embodiments of the arm 30, having a dome shaped rim 38 dividing the base piece 32 from the curved support piece 34, the rim 38 being designed to slide over the top end of the sleeve 12 when the arm 30 is inserted into the sleeve 12. FIG. 4b illustrates the support arm from a rear perspective. The rim prevents the arm 30 from progressing too far into the sleeve and provides further stability of the arm 30.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

Certain terms are used throughout the description to refer to particular method components. As one skilled in the art will appreciate, design and manufacturing companies may refer to a component by different names. This document does not intend to distinguish between components that differ in name but not function.

The terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other intermediate devices and connections. Moreover, the term “method” means “one or more components” combined together. Thus, a method can comprise an “entire method” or “sub methods” within the method.

The use of the word “a” or “an” when used in conjunction with the word “comprising” may mean “one”, or may also mean “one or more.” The use of the term “or” in the claims is used to mean “and/or” unless explicitly indicated to refer to alternatives only or the alternatives are mutually exclusive, although the disclosures supports a definition that refers to only alternatives and “and/or.”

The methods and systems disclosed and claimed herein can be made and executed without undue experimentation based on the level of disclosure presented. While the methods and systems have been described in terms of their preferred embodiments, it will be apparent to those skilled in the art that they are not limited to the exact steps described and may vary from such description without departing from the scope and spirit of the invention. The substitutes and modifications employed by one skilled in the art are deemed to fall within the scope of the invention.

What is claimed is:

1. A fence pole mounted device for hanging one or more items, the device comprising:
a pole cap seated over the top end of a vertical fence pole;
a hollow sleeve having a top end and a bottom end, the top end in communication with one side of the pole cap and the sleeve extending downward parallel against the fence pole;
one or more support straps in communication with the sleeve and further encircling the pole to adhere the sleeve to the pole;
at least one support arm having a first end and a second end, the first end sliding into the top end of the hollow sleeve and secured fixedly and the second end extending out perpendicularly from the first end, the second end further having one or more hooks on which to hang an object.

2. The device of claim 1 wherein the object is a potted plant.

3. The device of claim 1 wherein the object is security wire.

4. The device of claim 1 wherein the object is lighting.

5. The device of claim 1 wherein the support arm is curved.

6. A method for hanging one or more items from a fence, the method comprising:
seating a pole cap over the top end of a vertical fence pole, one side of the pole cap being in communication with a hollow sleeve having a top end and a bottom end, and the sleeve extending downward parallel against the fence pole;
adhering the sleeve to the fence pole using one or more support straps in communication with the sleeve and further encircling the pole;
sliding at least one support arm having a first end and a second end into the top end of the hollow sleeve and securing it fixedly, the second end of the support arm extending out perpendicularly from the first end, the second end further having one or more hooks on which to hang an object;
hanging one or more object on the hooks.

7. The device of claim 1 wherein the object is a potted plant.

8. The device of claim 1 wherein the object is security wire.

9. The device of claim 1 wherein the object is lighting.

10. The device of claim 1 wherein the support arm is curved.
